(19) United States
(12) Patent Application Publication
(10) Pub. No.: US 2024/0371227 A1
(43) Pub. Date: Nov. 7, 2024

(54) Vending Technology

(71) Applicant: T.W. Vending, Inc., River Falls, WI (US)

(72) Inventors: Jimmy JONES, JR., River Falls, WI (US); Colin ORASKOVICH, River Falls, WI (US)

(21) Appl. No.: 18/656,311

(22) Filed: May 6, 2024

Related U.S. Application Data
(60) Provisional application No. 63/464,355, filed on May 5, 2023.

(51) Int. Cl. G07F 7/00

(52) U.S. Cl. CPC G07F 7/005

(57) ABSTRACT

An improved vending machine that permits vending plural or multiple items in the course of a single customer transaction without the need for currency or special cards. The vending machine is particularly useful in controlled facilities such as prisons and jails. The vending machine includes cabinet having an ingress door for loading merchandise into an interior compartment of the cabinet and a merchandise egress and retrieval assembly; an automated merchandise delivery assembly disposed in the interior compartment of the cabinet for storing merchandise and for delivering merchandise to the merchandise egress and retrieval assembly; a electronic user interface communicatively connected to the cabinet and providing merchandise information and selection capability for the user, and providing user information for the apparatus; and a vending controller electronically communicatively connected to the user interface and to the automated merchandise delivery assembly, whereby the apparatus dispenses at least one item of merchandise without presentation of currency nor an external card device by the user. The vending machine is capable of dispensing a plurality of items of merchandise in a single transaction.

### 37 C.F.R. § 1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### CROSS-REFERENCE TO RELATED APPLICATIONS, IF ANY

If an Application Data Sheet(s) (ADS) has been filed in this application, it is incorporated by reference herein. Any applications claimed in an ADS for priority under 35 USC 119, 120, 121 or 365, and any and all parent, grandparent, great-grandparent, etc. applications of such applications, are also incorporated by reference, including any priority claims made in those applications and any material incorporated by reference, to the extent such subject matter is not inconsistent herewith.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to vending systems, apparatus and methods. Particularly, the invention relates to a vending machine. Most particularly, the invention relates to a smart vending machine that permits and facilitates, among other benefits, vending plural or multiple items in a single customer transaction, and improved and more secure transaction authorization by way of facial recognition or account numbers. The systems, apparatus and methods are particularly useful in controlled facilities such as prisons, jails, and other correctional institutions.

### 2. Background Information

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides a vending machine apparatus, method, method of manufacture and method of use which are practical, reliable, accurate and efficient, and which are believed to fulfill a need and to constitute an improvement over the background technology.

In one embodiment of the invention, the invention provides a smart vending machine that permits and facilitates, among other benefits:
vending plural or multiple items in a single customer transaction,
permitting secure transactions via facial recognition, account number, and or PIN number authorization, thus improving security and eliminating the necessity of the customer using cash, coins or other currency, credit cards, or other payment cards
enabling restrictions on ordering bases on various predetermined classifications; and
enabling placement of remote orders.

In one aspect, the invention provides a vending apparatus comprising a cabinet having an ingress door for loading merchandise into an interior compartment of the cabinet and a merchandise egress and retrieval assembly; an automated merchandise delivery assembly disposed in the interior compartment of the cabinet for storing merchandise and for delivering merchandise to the merchandise egress and retrieval assembly; a electronic user interface communicatively connected to the cabinet and providing merchandise information and selection capability for the user, and providing user information for the apparatus; and a vending controller electronically communicatively connected to the user interface and to the automated merchandise delivery assembly, whereby the apparatus dispenses at least one item of merchandise without presentation of currency nor an external card device by the user.

In another aspect, the invention provides a smart vending machine for use in jails, prisons and the like, comprising:
(a) a free standing cabinet having a front ingress door for loading merchandise into an interior compartment of the cabinet and a merchandise egress and retrieval assembly disposed below the ingress door;
(b) an automated merchandise delivery assembly disposed in the interior compartment of the cabinet for storing merchandise and for delivering merchandise to the merchandise egress and retrieval assembly;
(c) a user interface communicatively connected to the cabinet and providing merchandise information and selection capability for the user, and providing user information for the apparatus, the user interface having:
   (i) a forward facing camera for facial recognition, and
   (ii) an alpha-numeric keypad; and
(d) a single board computer vending controller electronically communicatively connected to the user interface and to the automated merchandise delivery assembly, whereby the apparatus:
   (i) dispenses at least one item of merchandise without presentation of currency nor an external card device by the user; and
   (ii) is capable of dispensing plural items of merchandise in a single transaction.

The systems, apparatus and methods are particularly useful in controlled facilities such as prisons, jails, and other correctional institutions.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a front elevation view of an embodiment of a vending machine of the present invention.

FIG. 2 is a front, right side perspective view of the vending machine.

FIG. 3 is front, left side perspective view of the vending machine.

FIG. 4 shows an embodiment of a control system of the vending machine.

FIG. 5 shows an embodiment of a Vending Controller of the vending machine.

FIGS. 6 to 15 show an embodiment of a process of using the vending machine of the present invention.

### DETAILED DESCRIPTION

The description that follows describes, illustrates and exemplifies one or more embodiments of a smart vending machine that permits and facilitates, among other benefits, vending plural or multiple items in a single customer transaction, and improved and more secure transaction authorization by way of facial recognition, account numbers, and/or PIN numbers. The systems, apparatus and methods are particularly useful in controlled facilities such as prisons, jails, and other correctional institutions. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

Vending machines are well known in the world. The first machines appeared in Europe in the late 1800's. Vending machines are automated mechanical or electromechanical machines that dispense snacks, beverages and other items to a customer who inserts cash (coin or bills) or a credit card for payment before receiving goods or services. Vending machines are typically not monitored. Recently, vending machines have also appears with or as part of micro-markets in institutions such as offices, municipal facilities, educational facilities, and correctional institutions such as prisons and jails. Vending machines have evolved in the last century, but at a relatively slow pace.

Vending machines have typically dispensed one (1) single item per payment transaction by a customer. This limitation has been endured despite the fact that vending machines may offer numerous items, in some cases in excess of thirty (30) unique products and that customers who use the vending require speed, efficiency, and convenience. Single item selection, payment and dispensing causes delays in use, duplication of transactions and other problems and inconveniences. Insofar as is known, no vending machine has been used which permits a customer to select, purchase, and receive plural products with one payment transaction. Nor are vending machines known which permit receipt of vended goods or services based on facial recognition or account numbers.

### I. The Base Vending Machine Hardware

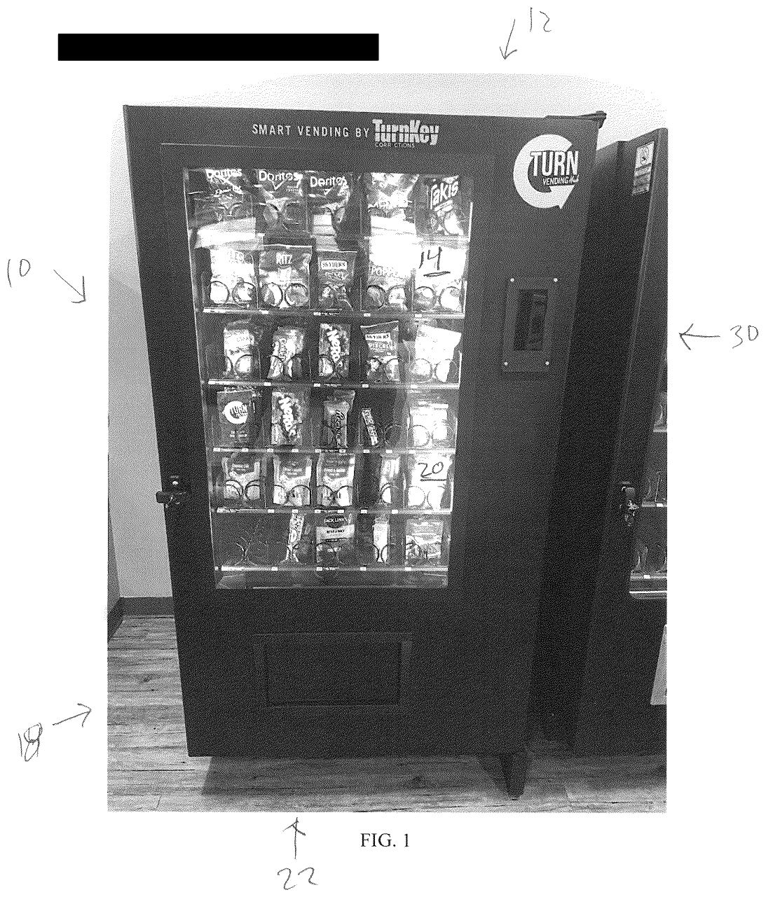

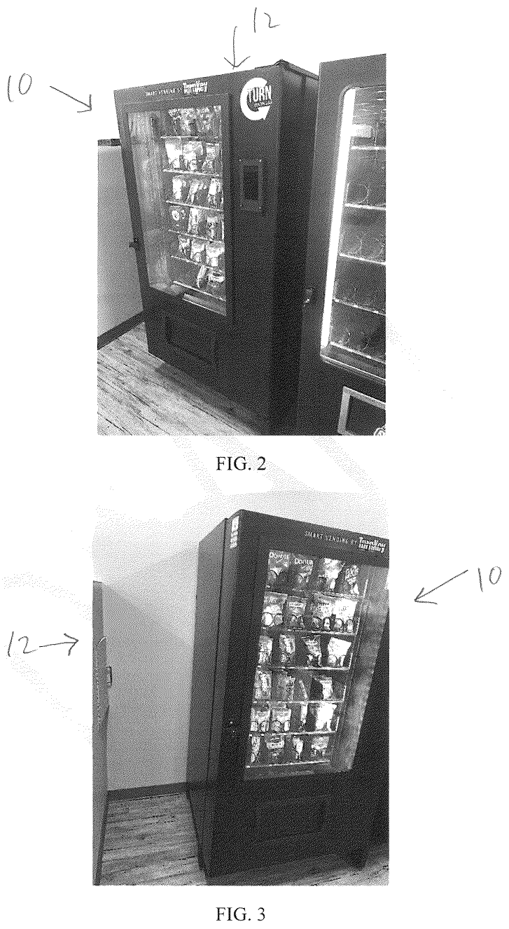

FIGS. 1 to 3 show an embodiment of the improved vending machine 10 of the invention. The vending machine 10 permits and facilitates, among other benefits, vending plural items in a single customer transaction (which may be multiples of the same item, multiple different items, or a combination of both), and improved and more secure transaction authorization by way of facial recognition, account numbers, ID numbers, and/or PIN numbers. The vending machine 10 may be considered a “smart” vending machine and has “smart” technology insofar as it permits purchasing merchandise without the necessity of using cash, tokens, prepaid cards, smart cards, or credit cards, and it permits ordering and payment remotely via an app. The systems, apparatus and methods are particularly useful in controlled facilities such as prisons, jails, and other correctional institutions.

In one embodiment of the invention, the vending machine 10 utilizes a known base automated merchandising device or system available in the market. An example device or system is provided by AMS Vending Machines, Inc. of Kearneysville, WV (USA).

The device 10 includes a cabinet 12 with fixed bottom, top, back and side walls which define an interior merchandise compartment 14. An automated merchandise delivery system 16 is disposed in the interior compartment 14. A front door 18 is attached to the cabinet 12. The front door 18 permits ingress and egress of product to the automated merchandise delivery system 16, and it has a clear viewing panel 20 that permits viewing of merchandise by users/customers. The front door 18 also has a lower merchandise retrieval device (and panel) 22 whereby the customer retrieves product that is selected and delivered by the system 16. Alternatively, the door may be disposed on a surface other than the front of the cabinet 12 and may omit the clear viewing panel whereby an electronic viewing screen provides a view of merchandise (goods or services) or list of merchandise to the user.

Significantly, the device 10 has a User Interface 30 disposed on the front door 18. The User Interface permits control of vending by the user. Such control includes selection of merchandise types (including plural types), control of merchandise numbers, facial recognition, and payment. The user interface 30 is a touch screen type of device, although it may alternatively be button type. In a further embodiment, the User Interface is a hand-held device, preferably a HUB™ Device provided by T.W. Vending of River Falls, WI (USA). It is the same or similar hand-held HUB Device that heretofore allows the users such as inmates to make calls, order commissary items, and the like. This is a benefit because, among other things, it is familiar to the users. It also allows them to perform those functions from the front of the vending machine. So, for instance, when an inmate wants to use a portable hand-held Hub Device to call a family member or friend but all of the portable hand-held Hub Devices in the jail or other institution has available are in use, the inmate can walk up to the vending machine and immediately make a phone call from the User Interface Device mounted to the vending machine and being used as the vending machine controller, because it is a familiar format.

In the embodiment shown, the Vending machine device 10 is a CLASSIC SNACK™ from AMS. It has a width of 35 to 39 inches, a height of 72 inches, and a depth of 35 inches. It has five (5) wide columns of product and has a helix delivery arrangement. It has a capacity of approximately 600 units of merchandise such as snacks, candy and the like. The general mechanical and electrical systems, components, and parts of device 10 are described in detail in Classic Models 35″ & 39″ Snack-Glass Front Merchandiser Illustrated Parts Manual L0206 Rev C, ECN 4478, published by AMS on Nov. 28, 2018. Still more features of the device 10 are disclosed in U.S. Pat. Nos. 6,145,699; 6,384,402; 6,520,373; 6,708,079; 6,794,634; 7,191,915; 7,343,220; 7,742,834; 7,446,302 and 8,003,931. All of these documents are incorporated by reference herein for all purposes.

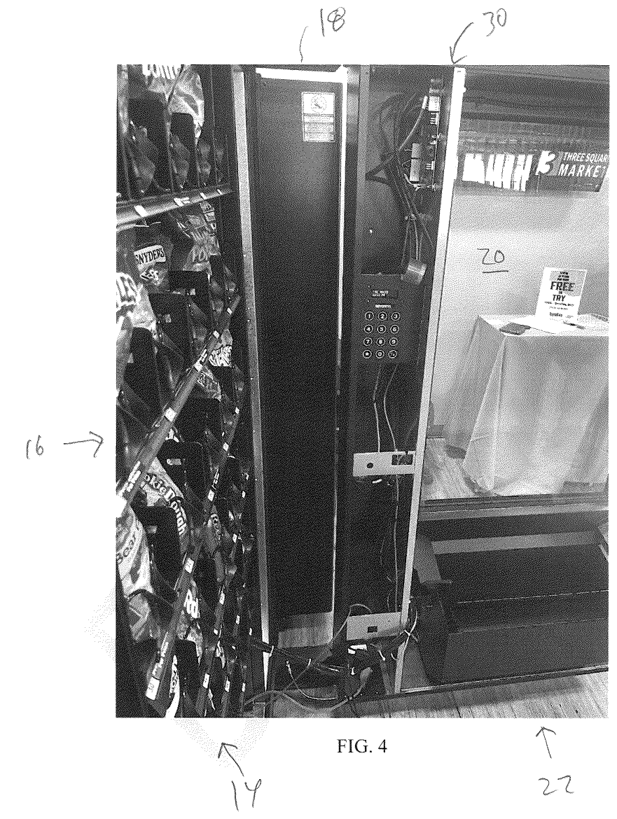

FIG. 4 shows an embodiment of an electronic control system 30 of the vending machine 10.

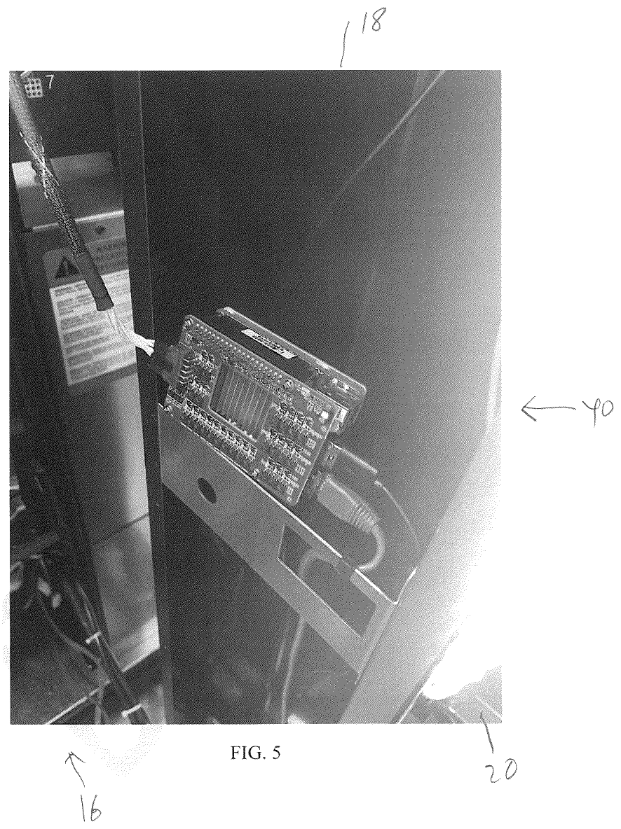

FIG. 5 shows an embodiment of a vending controller 40 of the control system 30. The vending controller 40 bridges the base electro-mechanical features of the vending machine 10 with the HUB™ Interface. The Hub may be Fixed to the device 10 or be a separate Mobile Hub Interface. In one embodiment, the vending controller comprises a Single Board Computer (SBC) including a central processing unit, RAM memory or memory capacity, networking support hardware, and peripheral device support hardware. A preferred SBC is the UP controller available from Aaeon®. Hub Interface technology permits continued function during power outages, null sale, and use safety. The Hub controller must confirm that the vending machine has power to it before it will confirm the transaction. The Hub had independent battery power and will continue to function even if there is no power to the vending machine. So the Hub controller needs to first confirm that the vending machine is even On before it allows for a vending transaction. Effectively, the controller will always have power even when the vending machine itself may not. Further, totaling and charging may be delayed until dispensing actually takes place so that mechanical, electrical, inventory or other errors are minimized or prevented.

The My Connection Hub or “The HUB” is a hand-held kiosk that allows users, particularly inmates in correctional facilities, to text, make phone calls, video visit, and access other services. The device is customizable for a particular facility. The device is battery powered, and the batteries are rechargeable. In one embodiment, the HUB utilizes an Android Operating System. The OS permits blacklist and whitelist customization of access to websites and information. The device has a camera that permits facial recognition for payment and other security measures. The device is approximately 4 inches wide by 6.5 inches high.

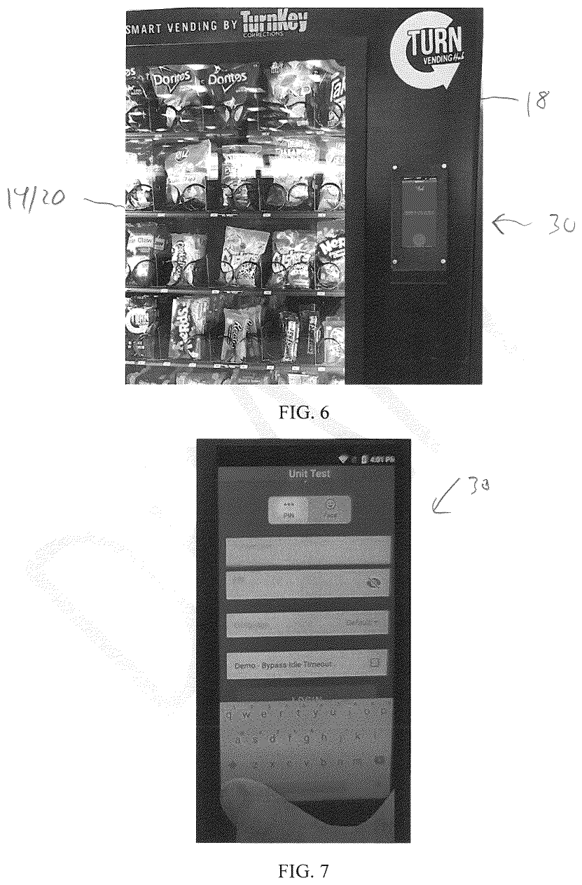

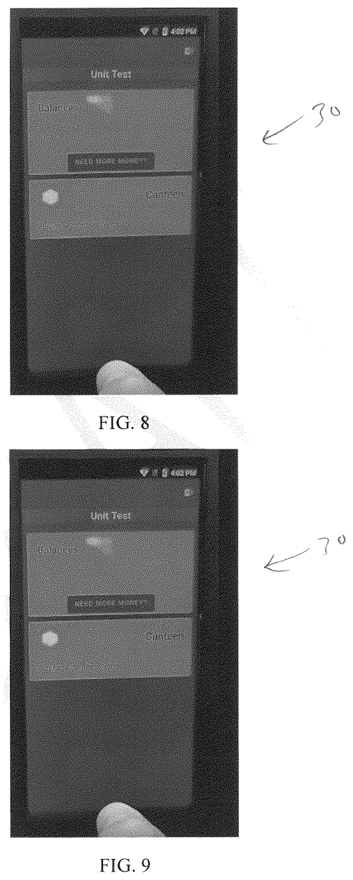

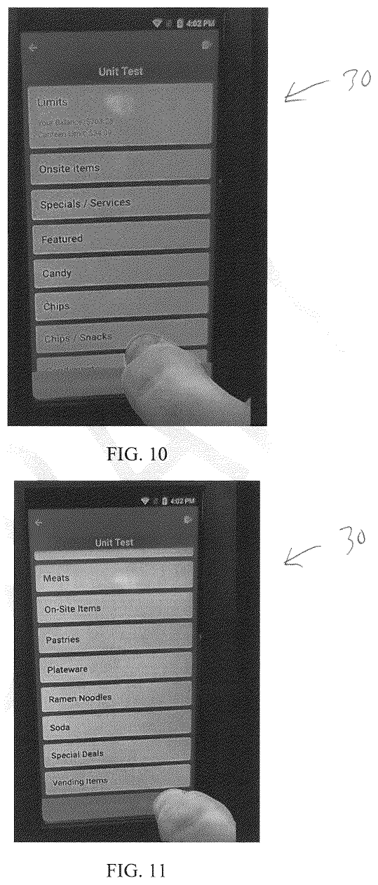

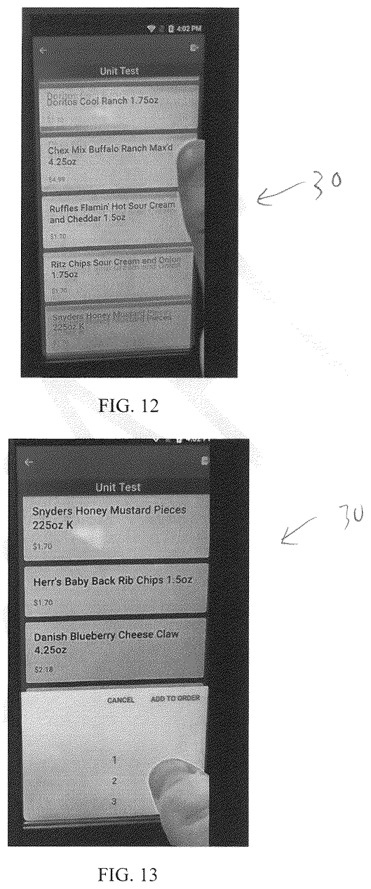

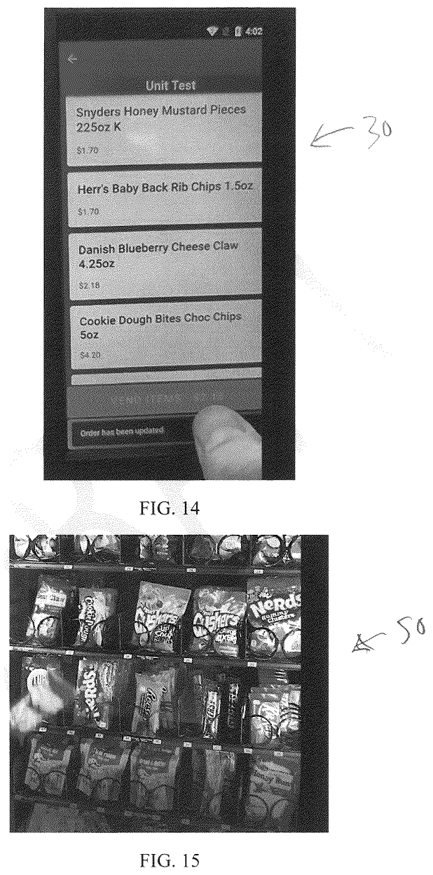

FIGS. 6-15 show an embodiment of a process 50 of using the vending machine 10. FIG. 6 shows an exemplary initial resting or default state. FIG. 7 shows an embodiment of a first step of a user inputting identification or account information or data. FIGS. 8 and 9 show a second step of viewing account balance information. FIGS. 10 and 11 show a third step of viewing merchandise information and making a first selection of a type of merchandise. FIG. 12 shows a fourth step of viewing and selecting a second type of merchandise. FIGS. 13 and 14 shows a fifth step of confirming the plural merchandise types and amounts thereof. FIG. 15 shows a final step wherein the plural items are being delivered.

The device 10 permits real time inventory management via TEAM™ Software (preferably TEAM 3™) provided by T.W. Vending, Inc. of River Falls, WI (USA). In one embodiment, the vending machine will not issue multiple items in one single transaction if it is not in communication with Team software and does not have smart technology available to it. Processing payment by way of TEAM permits inmate users to simply enter their account ID, number, or PIN to have funds drawn from their Inmate account. The tie between the vending machine and the user account on TEAM determines how much funds the inmate user can spend at the vending machine, as well as various restrictions that the user may have based for example on inmate health, dietary, age, or behavior data.

All of the embodiments of the device 10 utilize plural vend with one transaction functionality. In certain embodiments, the device 10 includes the following features:
A. Authentication of User by:
   (1) Facial Recognition.
   (2) Account, PIN or Inmate Code Input.
   (3) Optional Card Input and Reading, and/or Stolen Card recognition and processing.
B. Video Screen display of merchandise for security, anti-vandalism, or other purposes.
C. Control of Merchandise Vended by:
   (1) Age Restriction for select merchandise, such as products containing nicotine, alcohol or other regulated substances.
   (2) User Status such as User privileges, User Financial Status, User Medical or Dietary Status. This is particular useful for correctional facilities where an inmate may be afforded special privileges or privileges may be limited or revoked based on behavioral and/or safety considerations. Dispensing of snack or other foods and beverages may be controlled based on dietary or medical factors. Further, dispensing of items may be controlled based on inmates' financial status. For example, necessary or required items such as soaps, toothpaste, toothbrushes combs/brushes, vitamins and medicaments may be dispensed to indigent inmates while access to elective items such as snacks may be limited.

In embodiments of the device 10 that include a video screen, the clear front plate that permits viewing of merchandise by the customer may be omitted and replaced by a plate, panel or wall (or a cage added) that is less clear or opaque, but stronger, thereby rendering the device more resistant to vandalism. Vended items are still viewable on the HUB or other ordering device. Further, the camera for facial recognition authorization provides extra security in high risk environments.

### II. The Vending Controller

### 1. Purpose.

In one embodiment, the Vending Controller 50 manages communications between a Server and vendor-supplied Tower™ software (of Canberra, Australia) on a Linux Computer which manages the dispensing of vending machine items. The Vending Controller uses two methods to communicate: (1) HTTP calls and (2) Websockets.
Incoming requests:
   The vending controller accepts only websocket calls. This is because requests could occur at any time and this allows any incoming request to be received quickly and process the request logic.
Outgoing request:
   The vending controller send HTTPS requests to the team-server (or Team-web depending on route). This allows for direct URL communication and for response codes to be received for status code processing.

Logic within the Vending Controller attempts to ensure the Vending machine is online and communicating with the TKC Servers before attempting to dispense an item. The key goals of this system are:
Consistent vending
   If the vending machine is online, vend all the requested items
   If the vending machine is offline.
If the vending machine is offline, do NOT charge the requester's account for any requested items
   Only items that were successfully vended should be charged

### 2. Installation.

Installing the Vending-controller software involves:
Use the latest version of the Vending-controller-manager executable to update the Linux machine.
   See the README.md file for the vending-controller-manger, specifically:
      Moving/copying the vending-controller-manager to the intended location
      Running the vending-controller-manager software

### 3. Testing & Local Connection:

### A. Dependencies & Required Running Services:

team-service<--must be running
team-web<--contains executable dependencies built into the vending-controller

### B. Running and Testing the Software:

Plug in the ASUS station (the Single Board Computer (SBC) Linux computer) to a power source and wait for it to boot. In one embodiment, the SBC is an UP™ Controller available from Aaeon®. Alternative SBCs include a Raspberry Pi 5™ Controller available from Raspberry Pi.
   Upon boot, the user will be greeted with a login field for a user with a name of approximately vc-006 (or something similar)
   username: user
   password: user
      Note: The password field is hidden and will not display any text
Connect the device to the internet, or intranet
   (This README was written using a ethernet cable)
In the ASUS terminal, run hostname -I (capital i) to get the IP address that the Linux machine is communicating on
   Wireless connections may vary
If working locally, you will need to host team-service via localtunnel to allow communication with the Linux
   Purpose: team-service uses HTTPS:// protocols to communicate with HTTP and Websocket calls. localtunnel allows for the required wss:// calls to be transmitted and consumed as expected.
   In a terminal, run lt—port 8082 in the /team-service directory
   The terminal will provide a unique link. Open that link provided in a browser to active its communication over that forwarding port/URL
   In the vending-controller project, update the config.json file to point at the localtunnel route.
      config.json:
         ***EXAMPLE!!!***

```
{
  “ServerURL”: “https://fuzzy-dogs-own-68-65-34-142.loca.lt”,
  “WSURL”: “wss://fuzzy-dogs-own-68-65-34-142.loca.lt/ws”,
  “Production”: true
}
```

After updating the config.json file, the updated software routes need to be transferred to the Linux machine.
   This can be accomplished by transferring over the config.json file to the /home/user directory on the Linux machine via the SFTP protocol in Terminus
      See next main bullet-point for Terminus info
   Run the vending-controller-manager and select the [X] Vending Controller Installed: option to update the vending-controller with the updated routes
      See the README.md in the vending-controller-manager directory.
      Running the vending-controller-manager software
      The Linux computer will restart. Upon boot, the updated vending-controller software will be running using the updated routes
Optionally: Use the program Terminus to remotely connect and communicate with the Linux computer, both with SSH and SFTP
   In the Add Host option of Terminus, put the remote IP address into the field and connect
      Highly useful for issuing commands to a remote computer If ANY modifications are made to the vending-controller files, it will need to be recompiled as a Linux executable. That will be done by running the ./cross-compile.bat file in a git bash environment.
If this is the first time running the ASUS system locally, it may need to be registered at: http://localhost:4200/#/system/tools/registerstation.
   Otherwise, verify that it is running successfully at: http://localhost:4200/#/system/tools/version-manager

### 4. Vending Controller Process

A. On Boot:
   Get the core configurations accessed throughout the program
      The configuration most likely to cause development issues will be related to the URL routes listed in the config.json file during development.
         See the Developers section for an explanation of routing issues to consider during development
   Start two (2) Go Routines:
      The Websocket listener: ws.Connect
         This function will run forever due to the infinite for loop
      The station authentication check: station.IsRegistered-or-station.PendingRegistered
         This function will close once successfully ran to completion. However, if an error or fault occurs while running those specific functions, the NeverExit routine will attempt to try re-run those functions until they can successfully close
   Every ten (10) minutes:
      The vending controller will verify its registration status: station.IsRegistered
      The vending controller will check if an updated software package is available: station.CheckUpdates
         The controller checks the hard-coded version number in the main.go function against the version number assigned to it in the Admin webpage. If those numbers do not match, it will attempt to download the version assigned to it on the admin webpage
B. While Running:
   The key concept is that the vending-controller software should ALWAYS be running.
      Fail-safes are built-in to re-launch the software both upon boot and should a crash or unexpected issue occur
      If a crash is encountered and the software did not re-boot, that should be a top priority in fixing.
   While running, the core listener is the /vending-controller/ws/client.go file. This is where the websocket listens for incoming requests
      This is where incoming vending requests will be processed
      Items are dispensed out of the vending machine by using the provided API routes built by the company Smart Vending.
         Their software is called Tower and can be found in the /usr/local/bin/plankton/directory on the Linux machines
   The vending-controller runs two processes every 10-minutes:
      It verifies its registration status.
      It checks if a newer version of software is available for download and install
         If an update is found, it will update both the vending-controller software and the Tower software

### 5. The Complete Cycle for Vending an Item

This outlines the complete process from start to finish when a user requests an item from the vending machine. The goal is to provide an understanding of the whole process to assist in troubleshooting future issues. This is documentation of the process to provide better context to the code for future developers.
The user makes a vending machine item(s) request on The Hub™ or with an Inmate Kiosk™
   Those platforms are paired directly to one (1) Vending Machine. All requests made from any of those platforms (The Hub or Inmate Kiosk) will arrive at that singular vending machine.
   On The Hub and Inmate Kiosk, the vending machine items are listed within or near the Canteen section of the site.
      Susceptible to changes during development
   Users may request multiple items to be vended with a singular request.
      Upon submitting their request, the platform will send the following information to our team-service servers:
         The list of requested items to vend.
         The identifying KioskAddress for the requesting platform.
         Websockets will use this identifying field at the end of the process to signal to the platform whether the process was successful or not.
Team-service receives the HTTPS request, the KioskAddress, and list of order requests on /orders/vending route
   The server finds the paired vending machine with the requesting device.
   The server then creates a REDIS entry with a 10-second timeout with:
      KEY: storevendingitemsrequestuntilcompleted-{order-UUID-field}
      VALUE: {requested-items-list}
      This will allow for the vending-controller to request and look up that exact order from the team-service servers based on the UUID field.
   Team-service will then send a PING websocket to the identified vending-controller with a message field that contains ONLY:
      VendingControllerMacAddress: (this is similar to the KioskAddress, but instead is used to identify and call the specific vending-controller)
      GUID: This was the UUID field that was stored in REDIS. Later, this field will be reflected back to the team-service to look-up the specific vend request.
If the vending-controller is OFFLINE, that PING request will never be received by the vending-controller and the 10-second REDIS vend request will timeout.
   No further logic will occur on the team-service side
   The requesting user's account will NOT be charged.
If the vending-controller is ONLINE, the PING request will be consumed in the /vending-controller/wx/client.go websocket listener function case models.WS_Message_Ping.
   That websocket will unpack the message and call to team-service route /canteen/station/ping-success/vend-items with the parameters of the current vending controller's MacAddress and the specific order's UUID field.
If Team-service receives this call with those parameters, it knows that the vending machine is most likely online and a vend request should be success.
   Note: These is a very small chance the internet could go down between this HTTPS call and the subsequent vend request call about to be made.
   Within the Create VendingInmateOrder( ) function, the vend request order is found from REDIS by the UUID associated with it
      If that KEY cannot be found, then the order timed out and the requester's account is not charged.
         The platform the requester used also shows a message that the order was not successful.
      If the KEY is found, it will get the order information and then remove that REDIS field to keep duplicate requests from being processed.
   The team-service server will then stage the DB transactions and put the full order request into a new and different REDIS field using the associated UUID using an entry title: storevendingitemsrequestuntilcompleted-{order-UUID-field}
      This secondary REDIS entry will be used for order validation once the vending request is completed.
         The timeout is based on how large the order was; each item in the request adds additional seconds to the lifetime of the REDIS entry.
   Significantly, a websocket call is sent to BOTH the requester's platform AND to the associated vending-controller.
      The requester websocket is to signal the frontend to display a success message that the vending process is beginning and their request was successful.
      The vending-controller websocket request is signal to the vending machine to execute the vending dispense functions.
The vending-controller receives the websocket call on case models.WS_Message_Vend_Request.
   Note: There is a very small chance this call may fail. Some software scaffolding is roughly written in team-service in the function ValidateVendedItems( ) to validate orders, but none is yet in place to account for dropping a call here.
   The vending-controller sets the vending status to true and then loops through the list of items.
Using the vendor supplied Tower software that exists on the Linux boards, it creates a client that will access their pre-built API routes.
During each step of the loop, the following functions are run:
   Start a vending session for that client.
      This creates a cookie that is valid for a singular dispense session. Once a success dispense call is made, that cookie is forever invalidated.
   A singular item from the list makes a dispense request and is passed with that new cookie.
      The route ?action=dispense&code=%{coilNumber} is used to both ADD the item and DISPENSE. This route has proven very dependable.
      The other routes (?action=add&code={coilNumber} and ?action=dispense) have caused issues due to async calls not being received in the expected order.
         The two (2) above routes will most likely never be used due to this issue.
   Finally, ensure the expired cookie is removed from the header
      This step is marginally redundant, but it's a fail-safe to ensure proper logic flow.
After each dispense loop, aggregate the vended items into a list that will be used to validate the items dispensed match the requested items from the user.
Send that populated list back to the route /canteen/station/items-vended.
   The list sent on the POST request will be used to match against the list that was last stored in REDIS.
   The two lists are compared and any differences found in either list are noted.
   Any differences need to be reversed in the DB, or make a secondary invoice transaction refunding the user for the amount.

Although the apparatus/method has been described in connection with the field of vending, it can readily be appreciated that it is not limited solely to such field, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A vending apparatus comprising a cabinet having an ingress door for loading merchandise into an interior compartment of the cabinet and a merchandise egress and retrieval assembly; an automated merchandise delivery assembly disposed in the interior compartment of the cabinet for storing merchandise and for delivering merchandise to the merchandise egress and retrieval assembly; a electronic user interface communicatively connected to the cabinet and providing merchandise information and selection capability for the user, and providing user information for the apparatus; and a vending controller electronically communicatively connected to the user interface and to the automated merchandise delivery assembly, whereby the apparatus dispenses at least one item of merchandise without presentation of currency nor an external card device by the user.

2. The vending apparatus of claim 1, whereby the apparatus is capable of dispensing a plurality of items of merchandise in a single transaction.

3. The vending apparatus of claim 1, wherein the cabinet is free standing, the ingress door is located on a front face of the cabinet.

4. The vending apparatus of claim 3, wherein the ingress door has a viewing panel which permits viewing of merchandise by the user.

5. The vending apparatus of claim 3, wherein the cabinet and ingress door are opaque and have no viewing panel.

5. The vending apparatus of claim 3 wherein the merchandise egress and retrieval assembly is disposed below automated merchandise delivery assembly and is further disposed below the ingress door.

6. The vending apparatus of claim 1, wherein the automated merchandise delivery assembly is provided by AMS Vending Machines.

7. The vending apparatus of claim 1, wherein the user interface is connected to the cabinet and disposed on a front face.

8. The vending apparatus of claim 1, wherein the user interface is a remote device disconnected from the cabinet and electronically communicatively connected to the vending controller.

9. The vending apparatus of claim 1, wherein the user interface comprises a keypad.

10. The vending machine of claim 1, wherein the user interface comprises a camera.

11. The vending machine of claim 10, wherein the user interface further comprises facial recognition software.

12. The vending machine of claim 1, wherein the merchandise information and selection capability includes information identifying all merchandise available in the apparatus and selection capability for at least one item of merchandise.

13. The vending machine of claim 12, wherein the merchandise information and selection capability permits selection of a plurality of items of merchandise in a single transaction.

14. The vending machine of claim 1, wherein the user information is selected from the group of information consisting of user facial recognition, alpha-numerical account information, and numerical PIN information.

15. The vending machine of claim 1, wherein the vending controller is a Single Board Computer micro controller.

16. The vending machine of claim 15, wherein the microcontroller is an UP microcontroller.

17. The vending machine of claim 1, wherein the vending controller is communicatively connected to a TEAM system from T.W. Vending, Inc. storing user account information comprising a user name, a user password, user funds balance, and predetermined user privileges.

18. The vending machine of claim 17, wherein the user privileges are selected from the group consisting of user financial information, user health information, and user behavior information.

19. A vending machine for use in jails, prisons and the like, comprising:
a cabinet having an ingress door for loading merchandise into an interior compartment of the cabinet and a merchandise egress and retrieval assembly;
an automated merchandise delivery assembly disposed in the interior compartment of the cabinet for storing merchandise and for delivering merchandise to the merchandise egress and retrieval assembly;
a user interface communicatively connected to the cabinet and providing merchandise information and selection capability for the user, and providing user information for the apparatus; and
a vending controller electronically communicatively connected to the user interface and to the automated merchandise delivery assembly, whereby the apparatus:
dispenses at least one item of merchandise without presentation of currency nor an external card device by the user; and
is capable of dispensing plural items of merchandise in a single transaction.

20. A smart vending machine for use in jails, prisons and the like, comprising:
(a) a free standing cabinet having a front ingress door for loading merchandise into an interior compartment of the cabinet and a merchandise egress and retrieval assembly disposed below the ingress door;
(b) an automated merchandise delivery assembly disposed in the interior compartment of the cabinet for storing merchandise and for delivering merchandise to the merchandise egress and retrieval assembly;
(c) a user interface communicatively connected to the cabinet and providing merchandise information and selection capability for the user, and providing user information for the apparatus, the user interface having:
(i) a forward facing camera for facial recognition, and
(ii) an alpha-numeric keypad; and
(d) a single board computer vending controller electronically communicatively connected to the user interface and to the automated merchandise delivery assembly, whereby the apparatus:
(i) dispenses at least one item of merchandise without presentation of currency nor an external card device by the user, and
(ii) is capable of dispensing plural items of merchandise in a single transaction.
